(19) United States
(12) Patent Application Publication
(10) Pub. No.: US 2018/0157657 A1
(43) Pub. Date: Jun. 7, 2018

(54) METHOD, APPARATUS, CLIENT TERMINAL, AND SERVER FOR ASSOCIATING VIDEOS WITH E-BOOKS

(71) Applicant: GUANGZHOU ALIBABA LITERATURE INFORMATION TECHNOLOGY CO., LTD., Guangzhou (CN)

(72) Inventor: Yun Li, Guangzhou (CN)

(21) Appl. No.: 15/831,625

(22) Filed: Dec. 5, 2017

(30) Foreign Application Priority Data
Dec. 5, 2016 (CN) 201611105553.9

(51) Int. Cl. G06F 17/30; G06K 9/00; G06K 9/32; H04N 13/00; G10L 15/08

(52) U.S. Cl. CPC G06F 17/30014; G06K 9/00469; G10L 15/08; G06K 9/3283; H04N 13/007; G06K 9/3266

(57) ABSTRACT

Method, apparatus, client terminal, and server for associating videos with e-books are provided. The method for associating the video with the e-book includes: identifying at least one first content in the video; and comparing the first content with the second content in the e-book to determine the association relationship between the video and the e-book. The e-book includes at least one second content, and the association relationship includes the association relationship between a video part in the video corresponding to the first content and an e-book part in the e-book corresponding to the second content.

### CROSS-REFERENCES TO RELATED APPLICATION

This application claims the priority of Chinese Patent Application No. 201611105553.9, filed on Dec. 5, 2016, the content of which is incorporated by reference in its entirety.

### FIELD OF THE DISCLOSURE

The present disclosure generally relates to the technical field of e-books and videos, more particularly, relates to method, apparatus, client terminal, and server for associating videos with e-books.

### BACKGROUND

Film and television works adapted based on internet fiction, bestseller books and classics have always been highly favored by the public. During the video broadcast of such films and television plays, their corresponding publications or e-books are also enjoyed by the public.

In the prior art, a corresponding film or television play may be recommended in an e-book, or a corresponding e-book may be recommended in a film or television play. However, such conventional recommendations are static. Usually, even users can get the recommendations, users still need to manually search for recommended e-books or videos, and manually find the part of interest. Such conventional recommendations are only limited to directing the users to find the corresponding e-books or videos.

Nowadays, there are many e-books and videos made based on the same content source (homologous). They have a lot of similarities in content, role, plot arrangement and so on.

Therefore, there is a need to provide a new technical solution to improve at least one technical problem in the prior art.

### BRIEF SUMMARY OF THE DISCLOSURE

One aspect of the present disclosure provides a method for associating a video with an e-book, including: identifying at least one first content in the video; and comparing the first content with the second content in the e-book, so as to determine the association relationship between the video and the e-book, where the e-book includes at least one second content, and the association relationship includes an association relationship between the video part in the video corresponding to the first content and the e-book part in the e-book corresponding to the second content.

Optionally or additionally, the video and the e-book are from a same source.

Optionally or additionally, the first content is a text content or an audio content.

Optionally or additionally, identifying the first content in the video includes: acquiring a subtitle image of a subtitle region in a video; and identifying the corresponding text in the subtitle image by using an optical character recognition technology to be the first content.

Optionally or additionally, identifying the first content in the video includes: acquiring a voice segment in the video; and identifying the corresponding text in the voice segment by using a voice recognition technology to be the second content.

Optionally or additionally, the association relationship may include: an identifier of the video; and at least one of the starting position of the corresponding video and the ending position of the corresponding video.

Optionally or additionally, the second content is a text content or an audio content in the e-book.

Optionally or additionally, the association relationship includes an identifier of the e-book, and at least one of a start position and an end position of the corresponding e-book part.

Optionally or additionally, the at least one second content is the content in at least a paragraph or a chapter.

Optionally or additionally, comparing the first content with the at least one second content of the e-book includes: comparing the second content with a plurality of first contents.

Optionally or additionally, the method further includes: merging the video parts in the video corresponding to the plurality of first contents under the condition that the plurality of first contents corresponds to the second content.

Optionally or additionally, the method further includes determining the video part corresponding to the e-book part being used by the user based on the association relationship.

Optionally or additionally, the method further includes determining the e-book part corresponding to the video part being watched by the user based on the association relationship.

Another aspect of the present disclosure provides an apparatus for associating a video with an e-book. The apparatus includes: a device for identifying at least one first content in the video; and a device for comparing the first content with the second content in the e-book, so as to determine the association relationship between the video and the e-book, where the e-book includes at least one second content, and the association relationship includes an association relationship between the video part in the video corresponding to the first content and the e-book part in the e-book corresponding to the second content.

Another aspect of the present disclosure provides a client terminal provided to execute the following operations including: acquiring the association relationship between the video and the e-book, where the association relationship includes an association relationship between the corresponding video part in the video and the corresponding e-book part in the e-book; and based on the association relationship, switching between the corresponding video part and the corresponding e-book part.

Optionally or additionally, the video and the e-book are from the same source.

Optionally or additionally, the switching includes at least one of the switching from the corresponding video part to the corresponding e-book part and the switching from the corresponding e-book part to the corresponding video part.

Optionally or additionally, the association relationship may include: an identifier of the video; and at least one of the starting position of the corresponding video and the ending position of the corresponding video.

Optionally or additionally, the e-book includes at least one of the text e-book and the audio e-book.

Optionally or additionally, the association relationship includes an identifier of the e-book, and at least one of a start position and an end position of the corresponding e-book part.

Optionally or additionally, the association relationship further includes: an acquired address of the video or the e-book.

Another aspect of the present disclosure provides a client terminal, including a memory and a processor. The memory is used for storing instructions and the instructions are used for controlling the processor to execute following operations: acquiring the association relationship between the video and the e-book, where the association relationship includes an association relationship between the corresponding video part in the video and the corresponding e-book part in the e-book; and based on the association relationship, switching between the corresponding video part and the corresponding e-book part.

Another aspect of the present disclosure provides a client terminal, including a receiving device for receiving an association relationship between the video and the e-book. The association relationship includes an association relationship between the corresponding video part in the video and the corresponding e-book part in the e-book; and a processing device for, based on the association relationship, switching between the corresponding video part and the corresponding e-book part.

Another aspect of the present disclosure provides a server, including an apparatus for associating a video with an e-book. The server is configured to send the association relationship to the client terminal, so that the client terminal may switch between the corresponding video part and the corresponding e-book part.

Another aspect of the present disclosure provides a server configured to execute the following operations, including: identifying at least one first content in the video; and comparing the first content with the second content in the e-book, so as to determine an association relationship between the video and the e-book. The e-book includes at least one second content, and the association relationship includes an association relationship between the video part in the video corresponding to the first content and the e-book part in the e-book corresponding to the second content.

Another aspect of the present disclosure provides a server, including a memory and a processor. The memory is used for storing instructions and the instructions are used for controlling the processor to execute the disclosed method.

Another aspect of the present disclosure provides a server, including a processing device for identifying at least one first content in the video, and comparing the first content with the second content in the e-book to determine the association relationship between the video and the e-book. The e-book includes at least one second content, and the association relationship includes an association relationship between the video part in the video corresponding to the first content and the e-book part in the e-book corresponding to the second content; and a sending device for sending the association relationship to the client terminal, so that the client terminal may switch between the corresponding video part and the corresponding e-book part.

According to various embodiments of the present disclosure, users' experience of watching the video and/or reading the e-book may be improved.

A detailed description of an exemplary embodiment of the present disclosure is described below with reference to the accompanying drawings. Other features and advantages of the present disclosure will become clear.

### BRIEF DESCRIPTION OF THE DRAWINGS

The accompanying drawings, which are incorporated to the specification and constitute a part of the specification, illustrate embodiments of the disclosure. Along with the specification, the drawings are used to explain the principles of the present disclosure.

FIG. 1 is a schematic flow diagram of an exemplary method for associating a video with an e-book according to some embodiments of the present disclosure.

FIG. 2 is a schematic block diagram of an exemplary client terminal according to some embodiments of the present disclosure.

FIG. 3 is a schematic block diagram of another exemplary client terminal according to some embodiments of the present disclosure.

FIG. 4 is a schematic block diagram of an exemplary server according to some embodiments of the present disclosure.

FIG. 5 is a schematic block diagram of another exemplary server according to some embodiments of the present disclosure.

FIG. 6 is a schematic block diagram of another exemplary server according to some embodiments of the present disclosure.

FIG. 7 is a schematic diagram of an exemplary association system of a video and an e-book according to some embodiments of the present disclosure.

### DETAILED DESCRIPTION

Various exemplary embodiments of the present disclosure will now be described in detail with reference to the accompanying drawings. Unless specified otherwise, the relative arrangement of the components and steps in these embodiments, the numerical expressions and values do not limit the scope of the present disclosure.

The following description of at least one exemplary embodiment is merely for illustrative purposes, which is in no way providing limitations for the application or use of the present disclosure.

Related techniques, methods, and apparatuses known to those ordinary skills in the art may not be discussed in detail. In some cases, such techniques, methods and apparatuses will be considered as part of the specification.

In all examples shown and discussed here, all specific values should be interpreted as merely exemplary and are not limiting the scope of the present disclosure. Thus, other examples of exemplary embodiments may have different values.

It should be noted that similar reference numerals and letters indicate similar items in the accompanying figures. Thus, once a certain item is defined in one figure, there may be no need to further discuss in the subsequent drawings.

Various embodiments and examples according to the present disclosure will be described below with reference to the accompanying drawings.

According to various embodiments of the present disclosure, an association relationship may be established for an e-book and a video based on the similarities between the e-book and the video. For example, a paragraph or a chapter of the e-book may be associated with a plot fragment of the video. The user may thus be able to switch to the corresponding e-book part when viewing the video, or to switch to the corresponding video part when reading the e-book. Therefore, the user's experience may be improved.

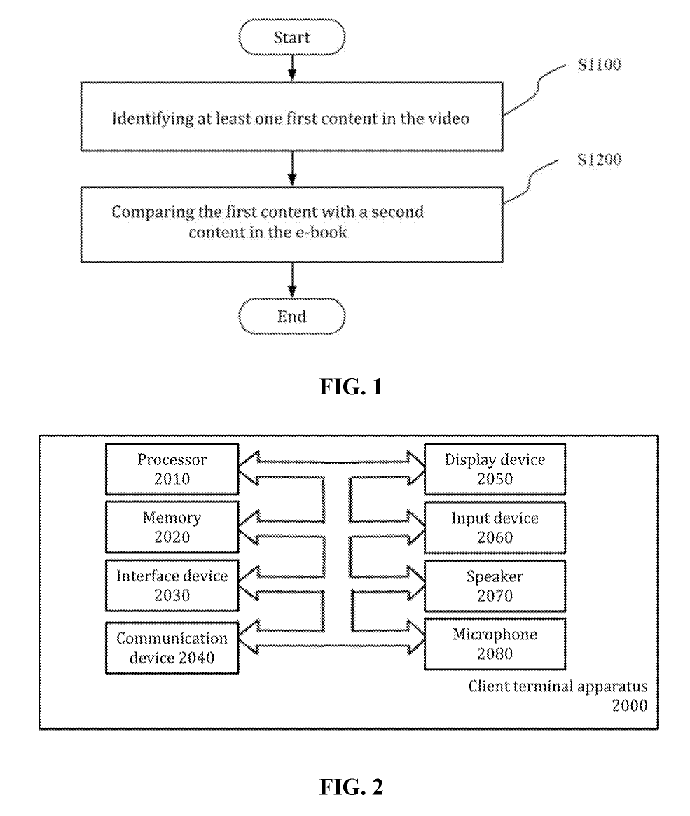

FIG. 1 illustrates a schematic flow diagram of a method for associating a video with an e-book according to some embodiments of the present disclosure.

As shown in FIG. 1, in Step S1100, at least one first content in the video is identified.

The first content may be a text content or an audio content. For example, if the corresponding e-book is in the form of a text, and the first content is a text content. The text content may be identified. For example, a subtitle image of a subtitle region in a video may be acquired, and the corresponding text in the subtitle image may be identified by using an optical character recognition technology. The corresponding text is recognized as the first content. Alternatively, a voice segment in the video may be acquired, and the corresponding text in the voice segment may be identified by using a voice recognition technology. The corresponding text is recognized as the first content.

Further, for example, if the corresponding e-book is an audio e-book, the first content may be audio content.

In Step S1200, the first content is compared with the second content in the e-book to determine the association relationship between the video and the e-book.

For example, the video and the e-book may be from a same source. The content of the e-book and the script of the video are basically consistent with each other. In this case, a better association relationship may be established between the e-book and the video.

The content in the e-book is referred to herein as a second content. The second content includes sentences (words or voices), paragraphs, etc., extracted from the e-book. The e-book includes at least one second content.

By comparing the first content with the second content, the corresponding relationship between the video and the e-book may be determined. Due to the fact that the content picked up from the video may be different from or less than the content of the e-book, the first content may correspond to a video part of the video. The time period of the video part may be longer than the time period of the video where the first content is located. Similarly, the second content may also be a subset of the corresponding e-book. Thus, the association relationship includes an association relationship between the video part in the video corresponding to the first content and the e-book part in the e-book corresponding to the second content.

For example, the association relationship may include an identifier of the video, at least one of the starting position of the corresponding video and the ending position of the corresponding video. For example, the location, which is used to identify a start position or an end position to play a video, may be a time in the video or an identifier of a frame, etc. For example, the television play includes a plurality of episode sets, and each episode set is a video file. In this case, the association relationship may include only an identifier of the video. Preferably, the duration of the video clip is fixed in this case. The association relationship may include only an identifier of the video and the initial position of the corresponding video part.

The e-book may be an e-book in the form of a text, and it may also be an e-book in the form of an audio. Accordingly, the second content may be a text content or an audio content in the e-book. The association relationship includes an identifier of the e-book, and at least one of a start position and an end position of the corresponding e-book part. The at least one second content is the context in at least a paragraph or a chapter. For example, the second content may be all of the content in a paragraph or a chapter. It may also be content selected from the paragraph or the chapter, e.g., the important content.

Since the first content is recognized from the video, the first content may not be complete. In one embodiment of the present disclosure, a second content is compared with a plurality of first contents. In this way, the recognition efficiency may be improved.

In addition, when a plurality of first contents corresponds to one second content, the corresponding video parts corresponding to the plurality of first contents in the video are merged. The “merge of the video parts in the video corresponding to the plurality of first contents” may be a merge of video parts corresponding to the plurality of first contents instead of the video files themselves.

After the association relationship is obtained, the user may switch easily between the video and the e-book by using the association relationship.

For example, based on the association relationship, the video part corresponding to the e-book part being used by the user may be determined. In this way, when the user is reading the e-book, by clicking on the content part of the e-book, the user may directly switch to the video part corresponding to the content currently being read by the user.

In addition, based on the association relationship, the e-book part corresponding to the video part being watched by the user may be determined. In this way, when the user is watching the video, by clicking on the video part, the user may directly switch to the e-book part (e.g., a paragraph and a chapter) corresponding to the content currently being watched by the user.

By using the technical solution of the embodiments of the present disclosure, the user's experience may be improved.

According to various embodiments of the present disclosure, the disclosed method may be embodied in the product through software, hardware and a combination of software and hardware. For example, based on the disclosed method, an apparatus for associating a video with an e-book may be provided. The apparatus includes: a device for identifying at least one first content in the video; and a device for comparing the first content with the second content in the e-book, so as to determine the association relationship between the video and the e-book. The e-book includes at least one second content, and the association relationship includes an association relationship between the video part in the video corresponding to the first content and the e-book part in the e-book corresponding to the second content.

For example, the video and the e-book may be from the same source. The first content is a text content and/or an audio content. For example, a device for identifying a first content in the video includes: a device for acquiring a subtitle image of a subtitle region in a video; and a device for identifying the corresponding text in the subtitle image may be identified by using an optical character recognition technology. For example, a device for identifying the first content in the video includes: a device for acquiring a voice segment in a video; and a device for identifying the corresponding text in the voice segment by using a voice recognition technology. For example, the association relationship may include: an identifier of the video;

and at least one of the starting position of the corresponding video and the ending position of the corresponding video.

For example, the second content may be a text content or an audio content in the e-book. For example, the association relationship includes an identifier of the e-book, and at least one of a start position and an end position of the corresponding e-book part. For example, the at least one second content is the context in at least a paragraph or a chapter. For example, a device for comparing the first content with the at least one second content of the e-book includes: a device for comparing the second content with a plurality of first contents. For example, the apparatus may also include: a device for merging the video parts in the video corresponding to the plurality of first contents when the plurality of first contents corresponds to one second content.

For example, the apparatus further includes a device for determining the video part corresponding to the e-book part being used by the user based on the association relationship. For example, the apparatus further includes a device for determining the e-book part corresponding to the video part being watched by the user based on the association relationship.

It is well known to those skilled in the art, along with the development of the electronic information technology such as the large-scale integrated circuit technology and the trend of software being similar to hardware, it is relatively difficult to clearly tell the boundary between the software and the hardware of a computer system. The reason is that any operation may be implemented by software, and it may also be implemented by hardware as well. The execution of any instructions may be completed by hardware, and may also be completed by software. Whether a hardware implementation scheme or a software implementation scheme is adopted for a certain machine function depends on non-technical factors such as the price, the speed, the reliability, the storage capacity and the change period. Therefore, for ordinary technicians in the technical field of electronic information, describing a technical scheme directly and clearly is the way to describe each operation in the scheme. Once the operations to be performed are known, a person skilled in the art may directly design a desired product based on the consideration of the non-technical factors.

A client terminal is also provided according to various embodiments of the present disclosure. The client terminal is configured to perform the following operations: acquiring the association relationship between the video and the e-book, where the association relationship includes an association relationship between the corresponding video part in the video and the corresponding e-book part in the e-book; and based on the association relationship, switching between the corresponding video part and the corresponding e-book part, where the association relationship may be formed according to the technical solution described above, and may also be generated by other manners, such as artificially generated by an operator.

The video and the e-book are from the same source. The switching includes at least one of the switching from the corresponding video part to the corresponding e-book part and the switching from the corresponding e-book part to the corresponding video part.

The association relationship includes an identifier of the video, and at least one of a start position and an end position of the corresponding video part.

The e-book includes at least one of an audio e-book and a text e-book.

The association relationship includes an identifier of the e-book, and at least one of a start position and an end position of the corresponding e-book part.

The association relationship further includes an acquired address of the video or the e-book.

In another exemplary aspect, FIG. 2 illustrates a schematic block diagram of a client terminal according to some embodiments of the present disclosure.

As shown in FIG. 2, the client terminal 2000 may include a processor 2010, a memory 2020, an interface device 2030, a communication device 2040, a display device 2050, an input device 2060, a speaker 2070, a microphone 2080, and so on.

The processor 2010 may be, e.g., a central processor CPU, a microprocessor MCU, etc. The memory 2020 may include, e.g., a ROM (read only memory), a random access memory (RAM), a non-volatile memory such as a hard disk, etc. The interface device 2030 includes, e.g., a USB interface, an earphone interface, etc.

The communication device 2040 may perform, e.g., wired or wireless communication.

The display device 2050 may be, e.g., a liquid crystal display screen, a touch display screen, etc. The input device 2060 may include, e.g., a touch screen, a keyboard and other users may input/output voice information through the speaker 2070 and the microphone 2080.

The client terminal shown in FIG. 2 is merely explanatory. FIG. 2 is in no way intended to limit the applications or use of the present disclosure.

The memory 2020 is used for storing instructions. The instructions are used for controlling the processor 2010 to execute the operations on the client terminal. For example, the instructions are used for controlling the processor 2010 to perform the following operations: acquiring the association relationship between the video and the e-book, where the association relationship includes an association relationship between the corresponding video part in the video and the corresponding e-book part in the e-book; and based on the association relationship, switching between the corresponding video part and the corresponding e-book part. It should be understood by those skilled in the art that although a plurality of devices is shown in FIG. 2, the present disclosure may only relate to some or portions of the devices including, for example, the processor 2010, the storage device 2020, etc. Instructions, such as computer-executable instructions, may be provided according to the disclosed method in the present disclosure. The client terminal 2000 may also implement other operations on the client terminal described above, which will not be repeated herein.

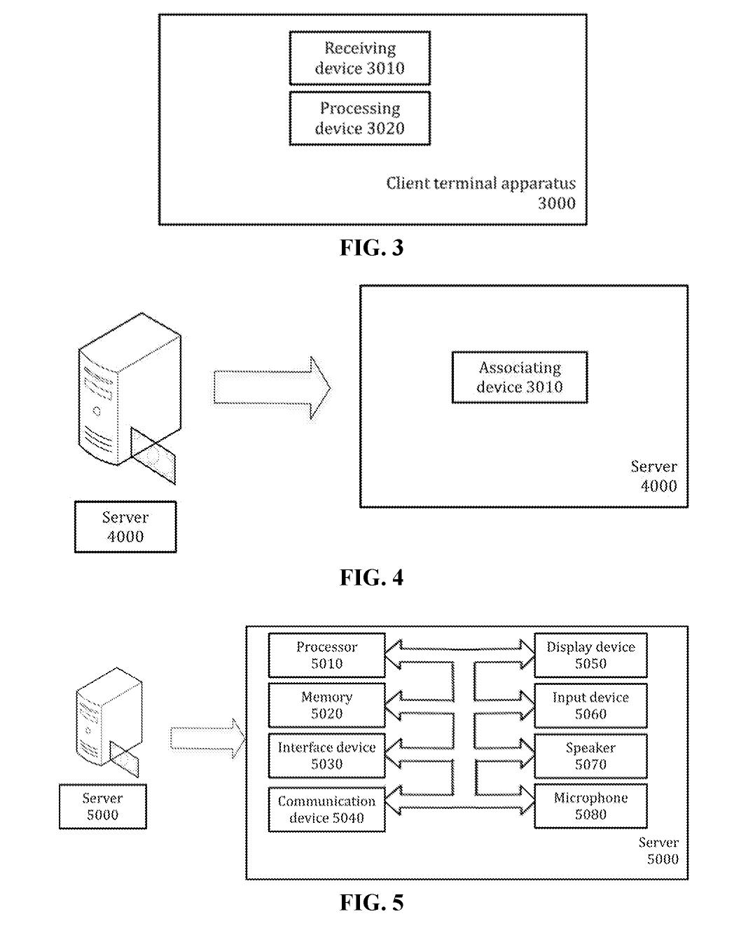

FIG. 3 illustrates a schematic block diagram of an exemplary client terminal according to various embodiments of the present disclosure.

As shown in FIG. 3, the client terminal 3000 includes a receiving device 3010 and a processing device 3020.

The receiving device 3010 is configured to receive the association relationship between the video and the e-book. The association relationship includes an association relationship between the corresponding video part in the video and the corresponding e-book part in the e-book.

The processing device 3020 is configured, based on the association relationship, to switch between the corresponding video part and the corresponding e-book part. The client terminal 3000 may also implement other suitable operations without limitation.

The server shown in FIG. 3 is merely explanatory and FIG. 3 is in no way intended to limit the present disclosure, its application or use.

The disclosed apparatus may be an independent device (e.g., it may be located on an independent rack). This independent device may also be integrated into a server to become a part of the server. In this case, the server is used to associate the video with the e-book, so that the user may switch between the video and the e-book. FIG. 4 illustrates a schematic block diagram of an exemplary server according to some embodiments of the present disclosure. As shown in FIG. 4, the server 4000 includes an apparatus (associating device), which associates the video with the e-book as disclosed herein. The server 4000 is further configured to send the association relationship to the client terminal. Thus, the client terminal may be used to switch between the corresponding video part and the corresponding e-book part.

In addition, the technical scheme of the electronic device may be described by describing various operations of the electronic device. In one embodiment, a server is also provided. The server is configured to perform the following operations: identifying at least one first content in a video; comparing the first content with the second content in the e-book to determine the association relationship between the video and the e-book. The e-book includes at least one second content, and the association relationship includes an association relationship between the video part in the video corresponding to the first content and the e-book part in the e-book corresponding to the second content.

FIG. 5 illustrates a schematic block diagram of a server according to some embodiments of the present disclosure.

As shown in FIG. 5, the server 5000 may include a processor 5010, a memory 5020, an interface device 5030, a communication device 5050, a display device 5050, an input device 5060, a speaker 5070, a microphone 5080, etc. Each device shown in FIG. 5 may have similar functions and configurations to the corresponding device shown in FIG. 2.

The electronic devices shown in FIG. 5 are merely explanatory. FIG. 5 is in no way intended to limit the present disclosure, its application or use.

In one embodiment, the memory 5020 is used for storing the instructions. The instructions are used for controlling the processor 5010 to execute the method for associating the video with the e-book as shown in FIG. 1. Those skilled in the art will appreciate that, although a plurality of devices is shown in FIG. 5, the present disclosure may only relate to some or portions of the devices including, e.g., the processor 5010, the storage device 5020, etc. Instructions, such as computer-executable instructions, may be provided according to the disclosed method in the present disclosure.

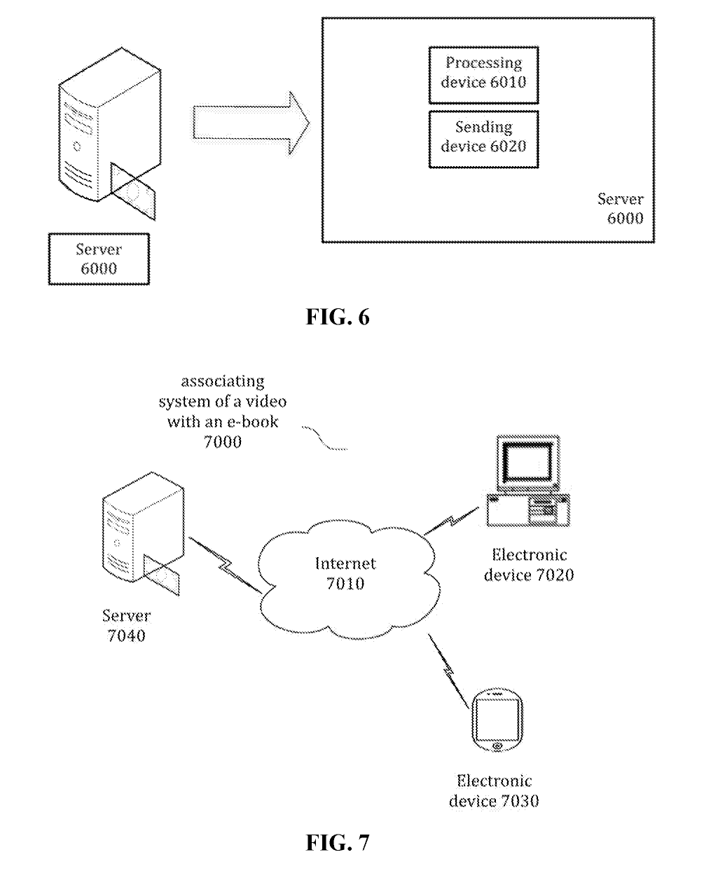

FIG. 6 illustrates a schematic block diagram of a server according to some embodiments of the present disclosure.

As shown in FIG. 6, the server 6000 includes a processing device 6010 and a sending device 6020.

The processing device 6010 is configured to identify the at least one first content in a video, and compare the first content with the second content in the e-book to determine the association relationship between the video and the e-book. The e-book includes at least one second content, and the association relationship includes an association relationship between the video part in the video corresponding to the first content and the e-book part in the e-book corresponding to the second content.

The sending device 6020 is configured to send the association relationship to the client terminal, so that the client terminal may switch between the corresponding video part and the corresponding e-book part.

The server shown in FIG. 6 is merely explanatory. FIG. 6 is in no way intended to limit the present disclosure, its application or uses. The server 6000 may also implement other suitable operations in the above-mentioned method.

In addition, those skilled in the art will appreciate that with the development of technologies, it is relatively difficult to clearly tell the boundary between the special server and the electronic device such as a computer and a notebook computer. Thus, the server described herein refers to an electronic device functioning as a server. For example, it may be a special server on the network. It may also be a terminal device capable of executing the functions of the server such as a personal computer, a notebook computer, etc.

FIG. 7 illustrates a schematic diagram of an association system of a video and an e-book according to one embodiment of the present disclosure. FIG. 7 is a schematic diagram showing only one illustrative example of the present disclosure and it cannot be used as limitation of the present disclosure.

As shown in FIG. 7, the association system between the video and the e-book includes electronic device 7020, electronic device 7030, and a server 7040.

The electronic device 7020 and electronic device 7030 may include the above described client terminal. The user may watch the video and/or read the e-book with the electronic device. The client terminal may be the electronic device itself. The client terminal may also be a certain function module in the electronic device, such as an application program on the electronic device, etc.

The server 7040 may be a server as described above.

The electronic device 7020, electronic device 7030, and the server 7040 communicate with each other through, e.g., a network 7010.

An exemplary embodiment of the present disclosure is described below with reference to FIG. 7.

(1) Selecting an E-Book and a Video of a Film/Television Work With the Content From the Same Source

For example, based on prior knowledge of the content, a content producer may determine and screen if the e-book and the video of the film/television work from the same source. Usually, films/television works are created directly or adapted from certain text contents, such as a novel, a playbook. The e-book also has specific content, which is created directly or adapted from certain text contents. Then, the video and the e-book are deemed to be from the same source.

For example, there is a popular novel “AAA” on an e-book reading platform. There is a television play adapted from the novel “AAA” on a cooperating platform. In this case, an association relationship between the e-book “AAA” and the video of “BBB” may be generated according to the technical scheme described in the embodiment of the present disclosure.

For example, the e-book of the novel “AAA” and the video of the “BBB” may be acquired in advance at the server 7040 or at other places. Then, the association relationship between the e-book and the video is generated based on the e-book and the video. The association relationship may be stored in an appropriate file.

For example, the text content of the video may be obtained by identifying subtitles or voices in the video “BBB”. The obtained text content of the video is compared with the main content in the e-book. In the comparison process, a threshold may be set, so that the text content of the video and the main content in the e-book are ensured to have a relatively great similarity.

The e-book “AAA” may be divided into one or more files according to chapters, volumes, etc. The video “BBB” may be divided into different episodes and stored in a plurality of video files. The video files may be local videos or online videos.

(2) Calculating and Labeling the Association Relationship Between the E-Book and the Video

When the video “BBB” has subtitles, the subtitle area in a key frame of the video may be obtained by using an image processing technology. For example, the corresponding text in the subtitle region may be identified using an optical character recognition technique. For example, a key frame may be extracted every second for identification. Multiple consecutive key frames with the same subtitle may be combined into one as a record. The corresponding text content (first content) is the characters recognized from the subtitle area. In addition, the identifier of the video, and the starting position and the ending position of the video part corresponding to the text content are recorded. The identifier of the video may be used to identify the video “BBB”. When the video “BBB” includes a plurality of sub-videos, the identifier is used for identifying the sub-videos.

When the video “BBB” does not have subtitles, the voice recognition technology may be adopted to obtain the text content. For example, consecutive voice segments are obtained, and the voice segments are recognized to obtain the text content. In addition, the identifier of the video, and the starting position and the ending position of the video part corresponding to the text content are recorded.

By the above processing method, the text content (the first content) corresponding to the video “BBB”, an identifier of the video, and a start position and an ending position of the video part corresponding to the text content may be obtained.

(3) Extracting the Text Content From the E-Book

The e-book “AAA” is parsed. For example, the text content in the e-book may be obtained by taking a sentence as a unit. The position information of the sentence in the e-book may also be acquired. For example, for an e-book with a fixed layout format (such as a PDF), the location information may include, but is not limited to, a page number, a description (e.g., coordinate values) of an area where the sentence is located in a page, etc. For example, for a non-fixed layout format (such as EPUB, pure text), the location information may include, but is not limited to, the total number of words counted from the start position of the e-book file, the length of the text content, etc. When the e-book file contains a plurality of files, the position information may further include an identifier of each file.

Preferably, a tree structure of paragraphs and chapters of the e-book may be obtained. In addition, a sentence set of each paragraph, a paragraph set of each chapter, etc., may be obtained. The e-book “AAA” may be divided into a plurality of files (sub-e-books). The e-book “AAA” and the sub-e-book of the e-book may be labeled by the e-book identifiers.

Through the above process, the e-book's identifier, the text content (the second content), position information, etc., may be obtained. In addition, the structure of the paragraphs and/or the chapters of the e-book may be obtained.

(4) Obtaining the Association Relationship Between the Video and the E-Book

Based on the above acquired information, the association relationship between the text content of the e-book and one or more than one adjacent text content of the video may be obtained. For example, a threshold may be set. When the consistency between the text content of the e-book and the text content of the video is greater than the threshold, the e-book and the video are considered corresponding to each other.

Here, the association relationship is determined using a text content of the e-book and a combination of a plurality of adjacent text contents of the video. The reason is that the content identified from the video may not be a complete sentence and may be very short. The association relationship between the video and the e-book may be more accurately determined by comparing a combination of a plurality of adjacent text contents of the video with a complete sentence of the e-book.

Based on the text content of the video and the text content of the e-book, a person skilled in the art may have many ways to compare the two and associate the two with each other. For example, character string matching, keyword searching, etc., may be used in an association process.

Each of the text content of the e-book may be compared with the text content of the video through a traversing mode. For example, if a plurality of sentences of a paragraph in the e-book is corresponding to the contents of a plurality of adjacent video parts, the plurality of video parts may be merged and the paragraph corresponds to the merged video part.

Here, a window may also be used to determine the association relationship. For example, m consecutive paragraphs are used as a window. Certain consecutive video parts, which have similarities to the text content of the paragraphs in the window, are obtained. The video part with highest similarity (e.g., the video part having the most contents consistent with the text content of the paragraph) is associated with the paragraph in the window.

In this way, the chapters and the volumes in the e-book may also be associated with each of the video part.

(5) Generating an Association Relationship

By utilizing the above obtained information, the association relationship between the e-book “AAA” and the video “BBB” may be generated. For example, the association relationship may include an identifier and an address of the e-book “AAA”, an identifier and/or an address of the video “BBB”, and the position information of each of the e-book part and the position information of each of the video part.

(6) Using the Association Relationship

The user may view the associated video part when reading the e-book “AAA”, or viewing the associated e-book part when watching the video by using the association relationship.

For example, when the user downloads the e-book “AAA” or the video “BBB”, the server 7040 sends a file containing the association relationship to the electronic devices 7020 and 7030. Optionally, the file containing the association relationship may be sent separately to the electronic device 7020, 7030.

When a user reads the e-book, the electronic devices 7020 and 7030 may remind the user to click the corresponding part (such as a paragraph, a chapter, etc.) in the e-book to switch to the relevant part of the associated video.

When a user is watching the video, user may switch to the corresponding chapter of the e-book by clicking on the corresponding part on the video player.

Although in the above example, the association relationship is generated at the server 7040, in various embodiments, the association relationship may be generated in the electronic devices 7020 and 7030. In addition, although in this example, the e-book is in the form of a text, the e-book may also be in a form of an audio.

In addition, the correlation operation between multiple devices may be conveniently realized based on the present disclosure. The e-book may be read on one device and the video may be viewed on another device at the same time. For example, based on the association relationship, the content of a novel may be read on a mobile phone and the associated video content may be watched on the television.

EEEE 1, a method for associating a video with an e-book includes: identifying at least one first content in the video; and comparing the first content with the second content in the e-book, so as to determine an association relationship between the video and the e-book, where the e-book includes at least one second content, and the association relationship includes the association relationship between the corresponding video part of the first content in the video and the corresponding e-book part of the second content in the e-book

EEEE 2, according to the method described by EEEE 1, where the video and the e-book are from the same source.

EEEE 3, according to the method described by EEEE 1, where the first content is a text content or an audio content.

EEEE 4, according to the method described by EEEE 3, where identifying the first content in the video includes: acquiring a subtitle image of a subtitle region in the video; and identifying the corresponding text in the subtitle image by using an optical character recognition technology to be the first content.

EEEE 5, according to the method described by EEEE 3, where identifying the first content in the video includes: acquiring a voice segment in a video; and identifying the corresponding text in the voice segment by using a voice recognition technology to be the second content.

EEEE 6, according to the method described by EEEE 1, where the association relationship may include: an identifier of the video; and at least one of the starting position of the corresponding video and the ending position of the corresponding video.

EEEE 7, according to the method described by EEEE 1, where the second content is a text content or an audio content in the e-book.

EEEE 8, according to the method described by EEEE 1, where the association relationship includes an identifier of the e-book, and at least one of a start position and an end position of the corresponding e-book part.

EEEE 9, according to the method described by EEEE 1, where the at least one second content is the content in at least a paragraph or a chapter.

EEEE 10, according to the method described by EEEE 1, where comparing the first content with the at least one second content of the e-book includes: comparing the second content with a plurality of first contents.

EEEE 11, according to the method described by EEEE 1, further including: merging the video parts corresponding to a plurality of first contents in the video under the condition that the plurality of first contents corresponds to the second content.

EEEE 12, according to the method described by EEEE 1, further including determining the video part corresponding to the e-book part being used by the user based on the association relationship.

EEEE 13, according to the method described by EEEE 1, further including determining the e-book part corresponding to the video part being watched by the user based on the association relationship.

EEEE 14, an apparatus for associating a video with an e-book includes: a device for identifying at least one first content in the video; and a device for comparing the first content with the second content in the e-book, so as to determine the association relationship between the video and the e-book, where the e-book includes at least one second content, and the association relationship includes an association relationship between the corresponding video part of the first content in the video and the corresponding e-book part of the second content in the e-book

EEEE 15, according to the apparatus described by EEEE 14, where the video and the e-book are from the same source.

EEEE 16, according to the apparatus described by EEEE 14, where the first content is a text content or an audio content.

EEEE 17, according to the apparatus described by EEEE 16, where the identifying device for identifying the first content in the video includes: an acquiring device for acquiring a subtitle image of a subtitle region in a video; and a device for identifying the corresponding text in the subtitle image by using an optical character recognition technology to be the first content.

EEEE 18, according to the apparatus described by EEEE 16, where the identifying device for identifying the first content in the video includes: an acquiring device for acquiring a voice segment in a video; and a device for identifying the corresponding text in the voice segment by using a voice recognition technology to be the second content.

EEEE 19, according to the apparatus described by EEEE 14, where the association relationship may include: an identifier of the video; and at least one of the starting position of the corresponding video and the ending position of the corresponding video.

EEEE 20, according to the apparatus described by EEEE 14, where the second content is a text content or an audio content in the e-book.

The EEEE 21, according to the apparatus described by EEEE 14, where the association relationship includes an identifier of the e-book, and at least one of a start position and an end position of the corresponding e-book part.

EEEE 22, according to the apparatus described by EEEE 14, where the at least one second content is the content in at least a paragraph or a chapter.

EEEE 23, according to the apparatus described by EEEE 14, where comparing the first content with the at least one second content of the e-book includes: comparing the second content with a plurality of first contents.

EEEE 24, according to the apparatus described by EEEE 14, further including: a merging device for merging the corresponding video parts of the plurality of first contents in the video under the condition that the plurality of first contents corresponds to a second content.

EEEE 25, according to the apparatus described by EEEE 14, further including a determining device for determining the video part corresponding to the e-book part being used by the user based on the association relationship.

EEEE 26, according to the apparatus described by EEEE 14, further including a determining device for determining the e-book part corresponding to the video part being watched by the user based on the association relationship.

EEEE 27, a client terminal to execute the following operations: acquiring the association relationship between the video and the e-book, where the association relationship includes an association relationship between the corresponding video part in the video and the corresponding e-book part in the e-book; and based on the association relationship, switching between the corresponding video part and the corresponding e-book part.

EEEE 28, according to the client terminal described by EEEE 27, where the video and the e-book are from the same source.

EEEE 29, according to the client terminal described by EEEE 27, where the switching includes at least one of the switching from the corresponding video part to the corresponding e-book part and the switching from the corresponding e-book part to the corresponding video part.

EEEE 30, according to the client terminal described by EEEE 27, where the association relationship may include: an identifier of the video; and at least one of the starting position of the corresponding video and the ending position of the corresponding video.

EEEE 31, according to the client terminal described by EEEE 27, where the e-book includes at least one of the text e-book and the audio e-book.

EEEE 32, according to the client terminal described by EEEE 27, where the association relationship includes an identifier of the e-book, and at least one of a start position and an end position of the corresponding e-book part.

EEEE 33, according to the client terminal described by EEEE 27, where the association relationship further includes: an acquired address of the video or the e-book.

EEEE 34, a client terminal includes a memory and a processor, where the memory is used for storing instructions and the instructions are used for controlling the processor to execute the following operations: acquiring the association relationship between the video and the e-book, where the association relationship includes the association relationship between the corresponding video part in the video and the corresponding e-book part in the e-book; and based on the association relationship, switching between the corresponding video part and the corresponding e-book part.

EEEE 35, a client terminal includes a receiving device for receiving the association relationship between the video and the e-book, where the association relationship includes an association relationship between the corresponding video part in the video and the corresponding e-book part in the e-book; and a processing device for, based on the association relationship, switching between the corresponding video part and the corresponding e-book part.

EEEE 36, a server including an apparatus for associating a video with an e-book described in EEEE 14, where the server is configured to send an association relationship to the client terminal, so that the client terminal may switch between the corresponding video part and the corresponding e-book part.

EEEE 37, a server configured to execute the following operations: identifying at least one first content in the video; and comparing the first content with the second content in the e-book, so as to determine the association relationship between the video and the e-book, where the e-book includes at least one second content, and the association relationship includes the association relationship between the corresponding video part of the first content in the video and the corresponding e-book part of the second content in the e-book.

EEEE 38, a server including a memory and a processor, where the memory is used for storing instructions and the instructions are used for controlling the processor to execute the method according to the EEEE 1.

EEEE 39, a server including a processing device for identifying the at least one first content in a video, and comparing the first content with a second content in an e-book to determine an association relationship between the video and the e-book, where the e-book includes at least one second content, and the association relationship includes an association relationship between the video part in the video corresponding to the first content and the e-book part in the e-book corresponding to the second content; a sending device for sending the association relationship to the client terminal, so that the client terminal may switch between the corresponding video part and the corresponding e-book part.

The present disclosure may include an apparatus, a method, and/or a computer program product. The computer program product may include a computer readable storage medium, which is loaded with computer readable program instructions for causing the processor to implement various aspects of the present disclosure.

The computer readable storage medium may be a tangible or non-transitory device that may store instructions to be used by the instruction execution device. The computer readable storage medium may be, for example, but is not limited to, an electric storage device, a magnetic storage device, an optical storage device, an electromagnetic storage device, a semiconductor memory device, or any appropriate combination thereof. A more specific example of a computer readable storage medium (a non-exhaustive list) includes a portable computer hard disk, a hard disk and a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical coding device(e.g., a punching card or a groove internal protrusion structure on which an instruction is stored), and any appropriate combination thereof. The computer readable storage medium used herein is not interpreted as an instantaneous signal itself, such as a radio wave or other freely propagated electromagnetic wave, electromagnetic wave transmitted through a waveguide or other transmission media (e.g., optical pulses transmitted through the optical fiber cable), or an electrical signal transmitted through the electric wire.

The computer readable program instructions described herein may be downloaded from a computer readable storage medium to each of computing/processing devices. The instructions may also be downloaded to an external computer or an external storage device through a network, such as the internet, a local area network, a wide area network and/or a wireless network. The network may include a copper transmission cable, an optical fiber transmission, a wireless transmission, a router, a firewall, a switch, a gateway computer, and/or an edge server. A network adapter card or network interface in each of the computing/processing devices receives computer readable program instructions from the network, and the computer readable program instructions are forwarded so that the instructions can be stored in a computer readable storage medium in each computing/processing device.

Computer program instructions for performing the operations of the present disclosure may be assembly instructions, instruction set architectures (ISA) instructions, machine instructions, machine-related instructions, microcode, firmware instructions, state setting data, or a source/target code written in any combination of one or more programming languages. The programming language includes an object-oriented programming language, such as Smalltalk, C++, etc., and a conventional procedural programming language, such as a C language or a similar programming language. The computer readable program instructions may be executed entirely on a user's computer, partially on the user's computer, as an independent software package, partially on a remote computer, or entirely on a remote computer or a server. In case of a remote computer, the remote computer may be connected to the user's computer through any kind of network, including a local area network (LAN) or a wide area network (WAN). The remote computer may be connected to an external computer (e.g., via the internet service provider for connection via the internet). In some embodiments, the electronic circuitry is personalized by utilizing the status information of the computer readable program instructions, such as a programmable logic circuit and a field programmable gate array (FPGA) or a programmable logic array (PLA). The electronic circuit may execute computer readable program instructions, so as to implement various aspects of the present disclosure.

Reference is made to the method, the apparatus (system) and flowcharts and/or block diagrams of the computer program product according to embodiments of the present disclosure to describe various aspects of the present disclosure. It should be understood that each block of the flowcharts and/or block diagrams, and combinations of blocks in the flowcharts and/or block diagrams, may be realized through computer readable program instructions.

These computer readable program instructions may be provided to a general purpose computer, a special computer or a processor of other programmable data processing devices. A machine is produced, such that when the instructions are executed by a processor of a computer or other programmable data processing devices, an apparatus is created for realizing the function/action specified in one or more blocks in the flow charts and/or the block diagram.

The computer readable program instructions may also be stored in a computer readable storage medium. The instructions enable the computer, the programmable data processing device and/or other devices to work in a specific manner. Thus, the computer readable medium storing the instructions includes a manufacturing product which includes instructions for implementing various aspects of the functions/acts specified in the flowcharts and/or one or more blocks in the block diagrams.

Computer readable program instructions may also be loaded onto a computer, other programmable data processing device, or other devices. A series of operation steps are executed on the computer, other programmable data processing devices or other devices to generate a computer-implemented process. Thus, the instructions in the computer, other programmable data processing devices, or other devices are executed to implement the functions/acts specified in the flowcharts and/or one or more blocks in the block diagrams.

The accompanying flowcharts and block diagrams in the drawings show multiple systems, methods, and system structure, functions, and operations implemented by the computer programmable product according to embodiments of the present disclosure. In this regard, each block in the flowcharts or block diagrams may represent a module, a program segment, or a portion of the instructions. The module, the program segment, or a portion of the instructions includes one or more executable instructions for achieving a specified logical function. In some alternative implementations, the functions noted in the blocks may also occur in an order different from the order indicated in the drawings. For example, two consecutive blocks may be executed substantially in parallel, and sometimes they may be performed in reversed order depending on the functions involved in the present disclosure. It should be noted that, each block in the block diagrams and/or the flowcharts and a combination of the blocks in the block diagrams and/or the flowcharts may be implemented by a special hardware-based system which performs specified functions or actions. They may also be implemented by a combination of special hardware and computer instructions. It is well known to those skilled in the art that the methods which are realized in a hardware mode, in a software mode, and a mode of combining software and hardware are equivalent.

The embodiments of the present disclosure have been described above. The above description is exemplary and is not exhaustive, and is not limited by the disclosed embodiments. Without departing from the scope and spirit of the illustrated embodiments, many modifications and variations will be obvious to those with ordinary skill in the art. The terms used herein are selected to best explain the principles of the embodiments, practical application or technical improvement in the market, or make ordinary skilled in the art to understand all the disclosed embodiments in the present disclosure. The scope of the present disclosure is defined by the appended claims.

What is claimed is:

1. A method for associating a video with an e-book, comprising:
identifying at least one first content in the video;
comparing the first content with a second content in the e-book to determine an association relationship between the video and the e-book,
wherein the e-book comprises at least one second content, and the association relationship comprises an association relationship between a video part in the video corresponding to the first content and an e-book part in the e-book corresponding to the second content.

2. The method according to claim 1, wherein:
the video and the e-book are from a same source.

3. The method according to claim 1, wherein:
the first content is one or more of a text content and an audio content.

4. The method according to claim 1, wherein identifying the at least one first content in the video comprises:
acquiring a subtitle image of a subtitle region in the video; and
identifying a corresponding text in the subtitle image by using an optical character recognition technology to be the first content.

5. The method according to claim 1, wherein identifying the at least one first content in the video comprises:
acquiring a voice segment in the video; and
identifying a corresponding text in the voice segment by using a voice recognition technology to be the second content.

6. The method according to claim 1, wherein the association relationship comprises:
an identifier of the video; and
at least one of a starting position of a corresponding video and an ending position of the corresponding video.

7. The method according to claim 1, wherein:
the second content is one or more of a text content and an audio content in the e-book.

8. The method according to claim 1, wherein the association relationship comprises:
an identifier of the e-book; and
at least one of a start position and an end position of the corresponding e-book part.

9. The method according to claim 1, wherein:
the at least one second content is a content in at least one of a paragraph or a chapter.

10. The method according to claim 1, wherein comparing the first content with the at least one second content of the e-book comprises:
comparing the second content with a plurality of first contents.

11. The method according to claim 10, further comprising:
merging the video parts in the video corresponding to the plurality of first contents under the condition that the plurality of first contents corresponds to the second content.

12. The method according to claim 1, further comprising:
determining the video part corresponding to the e-book part being used by a user based on the association relationship.

13. The method according to claim 1, further comprising:
determining the e-book part corresponding to the video part being watched by a user based on the association relationship.

14. A client terminal, comprising:
a memory, storing program instructions; and
a processor, coupled to the memory and, when executing the program instructions, configured for:
acquiring an association relationship between a video and an e-book, wherein the association relationship comprises an association relationship between a corresponding video part in the video and a corresponding e-book part in the e-book; and
switching between the corresponding video part and the corresponding e-book part based on the association relationship.

15. The client terminal according to claim 14, wherein
the video and the e-book are from a same source.

16. The client terminal according to claim 14, wherein the association relationship comprises:
an identifier of the video; and
at least one of a starting position of a corresponding video and an ending position of the corresponding video.

17. The client terminal according to claim 14, wherein the association relationship comprises:
an identifier of the e-book; and
at least one of a start position and an end position of the corresponding e-book part.

18. The client terminal according to claim 14, further comprising:
a receiving device, configured for receiving the association relationship between the video and the e-book; and
a processing device, configured for, based on the association relationship, switching between the corresponding video part and the corresponding e-book part.

19. A server, comprising:
a memory, storing program instructions for a method for associating a video with an e-book; and
a processor, coupled to the memory and, when executing the program instructions, configured for:
identifying at least one first content in the video;
comparing the first content with a second content in the e-book to determine an association relationship between the video and the e-book,
wherein the e-book comprises at least one second content, and the association relationship comprises an association relationship between a video part in the video corresponding to the first content and an e-book part in the e-book corresponding to the second content.

20. The server according to claim 19, wherein the server is further configured for sending the association relationship to an client terminal for the client terminal to switch between a corresponding video part and a corresponding e-book part.
